(19) United States
(12) Patent Application Publication
(10) Pub. No.: US 2006/0234042 A1
(43) Pub. Date: Oct. 19, 2006

(54) Etched dielectric film in microfluidic devices

(76) Inventors: Rui Yang, Austin, TX (US); Nathan P. Kreutter, Austin, TX (US); Nanyakkara L.D. Somasiri, Austin, TX (US)

Correspondence Address: 3M INNOVATIVE PROPERTIES COMPANY, PO BOX 33427, ST. PAUL, MN, 55133-3427, US

(21) Appl. No.: 11/318,714

(22) Filed: Dec. 27, 2005

Related U.S. Application Data
(63) Continuation-in-part of application No. 10/792,535, filed on Mar. 3, 2004.
Application No. 10/792,535 is a continuation-in-part of application No. 10/235,465, filed on Sep. 5, 2002.

(51) Int. Cl. B32B 7/12; B32B 3/00

(52) U.S. Cl. 428/344; 428/209

(57) ABSTRACT

An etched dielectric film having an adhered etch stop layer for use in microfluidic devices. Channels, recesses, and other features can be etched into the films to make them suitable for use in microfluidic devices.

This application is a continuation-in-part application of currently pending U.S. patent application Ser. No. 10/792535, filed Mar. 3, 2004, which is a continuation-in-part application of currently pending U.S. patent application Ser. No. 10/235465, filed Sep. 5, 2002, both of which are hereby incorporated by reference.

### FIELD

The invention relates to dielectric films useful in microfluidic devices.

### BACKGROUND

Areas such as medical diagnostics, forensics, genomics, environmental monitoring, and contaminant testing often require routine repetitive testing for detection and identification of chemical compounds. Frequently, parallel screening methodologies are used to analyze the large volume of samples in these various fields. Despite improvements in parallel screening methods and other technological advances, such as robotics and high throughput detection systems, current screening methods still have a number of associated problems. For example, screening large numbers of samples using existing parallel screening methods have large space requirements to accommodate the samples and equipment, e.g., robotics, high costs associated with equipment and non-reusable supplies, and high reagent requirements necessary for performing the assays.

Available reaction volumes are often very small due to limited availability of the compound to be identified. Such small volumes lead to errors associated with fluid handling and measurement, e.g., due to evaporation, dispensing errors, and the like. Additionally, fluid-handling equipment and methods are typically unable to handle these small volumes with acceptable accuracy. The shortcomings of standard analysis techniques are promoting development efforts in the area of microfluidic analysis.

Since the mid 90's researchers have been working on methods to miniaturize complex laboratory analysis systems down to a size that would make them portable. These miniaturized chemical analysis systems are called “lab on a chip”.

These miniaturized analysis systems have many advantages over existing large-scale laboratory equipment. Primarily, portability, physical size, simple operation, and low cost allow hand held equipment to be transported with ease to the location where the information is required and to the source of the analyte. The markets in which this technology would be most useful include medical diagnostics, forensics, agriculture, infectious disease control, environmental monitoring, homeland security, and military applications. Several other areas would also benefit from more efficient laboratory analysis such as analytical chemistry, chemical synthesis, cell biology, molecular biology, drug discovery, genomics, proteomics, and diagnostics.

These lab on a chip systems contain one or more of the following elements: one or more electrodes; reservoirs for buffer solutions, waste, reagents and other fluids; reaction chambers (e.g., immuno-reaction chamber); channels for fluid separation or delivery; capillary electrophoresis structures; heaters; and optical interfaces.

### SUMMARY

One aspect of the present invention provides an article comprising a microfluidic device comprising (1) a dielectric film having a first surface and a second surface and comprising an etchable polymer, said dielectric film having an etched opening extending from said first surface to said second surface; and (2) an adjacent layer adhered to said second surface of said dielectric film, wherein said adhered layer is not etchable in the same manner as the dielectric layer.

Another aspect of the present invention provides a method comprising providing a dielectric film having a first surface and a second surface and comprising an etchable polymer and having an adhered layer adjacent said second surface of said dielectric film; and etching an opening from said first surface to said second surface of said dielectric film wherein said adhered layer acts as an etch stop during the etching of said opening.

Another aspect of the present invention provides an article comprising a microfluidic device comprising (1) a dielectric film having a first surface and a second surface and comprising a chemically etchable polymer selected from the group consisting of polyimides having carboxylic ester units in the polymeric backbone, liquid crystal polymers, and polycarbonates, said dielectric film having a chemically etched opening extending from said first surface to said second surface; and (2) an adhered layer adjacent said second surface of said dielectric film, wherein said adhered layer is not chemically etchable in the same manner as the dielectric layer.

Another aspect of the present invention provides a method comprising providing a dielectric film having a first surface and a second surface and comprising a chemically etchable polymer selected from the group consisting of polyimides having carboxylic ester units in the polymeric backbone, liquid crystal polymers, and polycarbonates and having an adhered layer adjacent said second surface of said dielectric film; and chemically etching an opening from said first surface to said second surface of said dielectric film wherein said adhered layer acts as an etch stop during the chemical etching of said opening.

An advantage of at least one embodiment of the present invention is that a microfluidic device with a polymer substrate allows high volume low cost manufacturing.

An advantage of at least one embodiment of the present invention is that it allows the creation of microfluidic channels of controlled geometry in polymeric of substrates.

An advantage of at least one embodiment of the present invention is that it allows a feasible and cost-effective method of electrode formation, configuration and integration in a microfluidic device.

An advantage of at least one embodiment of the present invention is that it provides the ability to form complex laminate structures.

### BRIEF DESCRIPTION OF THE FIGURES

FIG. 1 illustrates an embodiment of the present invention comprising an etched channel formed in a dielectric film.

FIG. 2 is a photomicrograph digital image of a cross section of a polyimide film of the present invention having several etched channels.

FIG. 3 is a scanning electron micrograph digital image of a top view of the film shown in FIG. 2.

FIG. 4 illustrates an embodiment of the present invention having a cap layer over an etched channel, thereby creating a microfluidic tube.

FIG. 5 illustrates an embodiment of the present invention in which a channel is etched in one layer of a multilayer construction.

FIG. 6 illustrates an embodiment of the present invention in which electrodes are located at the bottom of an etched channel.

FIG. 7 illustrates an embodiment of the present invention in which electrodes are located in the sidewalls of an etched channel.

FIGS. 8a and 8b illustrate embodiments of the present invention having multiple conductive bumps in a well (FIG. 8a) and in a channel (FIG. 8b).

FIG. 9 illustrates an embodiment of the present invention in which conductive bumps are located in a closed etched channel.

FIG. 10 illustrates an embodiment of the present invention in which electrodes are located in a cap layer covering an etched channel.

FIG. 11 illustrates an embodiment of the present invention in which an etched channel contains sampling wells.

FIG. 12 illustrates an embodiment of the present invention in which a reaction chamber is formed by partially or fully etching an opening in a dielectric layer.

FIG. 13 illustrates an embodiment of the present invention in which features are formed in a reaction chamber to create a “lab on a chip” structure.

FIG. 14 illustrates an embodiment of the present invention that includes a feature for connecting a fluid tube to an etched indention through a cap layer.

FIG. 15 illustrates an embodiment of the present invention that includes a device having an etched channel and metal layers on its outer surfaces.

FIG. 16 illustrates an embodiment of the present invention that includes a microfluidic device having an integrated circuit chip mounted on the backside.

FIG. 17 illustrates an embodiment of the present invention that includes a microfluidic device having an adhered etch stop layer.

### DETAILED DESCRIPTION

The present invention provides dielectric films as substrates for microfluidic devices that include a flexible dielectric substrate film having indentions and/or openings and optionally copper conductive traces. Formation of openings and indentations, also referred to herein as vias, through holes, recesses, channels, trenches, wells, reservoirs, reaction chambers, and the like, creates changes of thickness in areas of the dielectric films. Indentations are regions of controlled depth that extend only part way through the entire thickness of a single dielectric layer. Openings extend through the entire thickness of at least a single dielectric layer. In at least one embodiment of the present invention, an adhered layer will be located on one side of an opening.

Articles having channels and electric circuits provide a way to introduce microfluidic elements into electronic packages. It is conceivable to use micro-electromechanical systems (MEMS) devices, connected through the electric circuits, to analyze chemical fluids and analytes flowing through the channels formed in the circuit substrate. An analytical device of this type could provide channels on the same substrate as the electrical circuit. Use of photolithography, in this case, allows design freedom and very precise alignment and positioning of device features.

Typical microfluidic devices have channels with widths between about 10 and about 200 μm, more typically between about 15 and about 100 μm, and depths between about 10 and about 70 μm. The challenge of integrating microelectronics and fluids in a concise manufacturable “package” is one of the primary obstacles to commercial success in this field. A suitable package may be rigid or flexible. A rigid package may include a flexible circuit with one or more rigidizing layers. One of the key benefits of flexible circuits is their application as connectors in small electronic devices such as portable electronics where there is only limited space for connector routing. It will be appreciated that reduction in thickness of flexible circuits or portions of flexible circuits will lead to greater circuit flexibility as well as allowing inclusion of new features into flexible electrical interconnects. This increases versatility in the use of flexible circuits particularly if the reduction in thickness of the dielectric substrate provides a means of manipulating fluids within the substrate.

Microfluidic features (e.g., vias, channels, reservoirs, reactors and the like) can now be realized using a process to selectively reduce or completely remove the dielectric film thickness through a cost-effective wet chemical etching method or other etching methods. The advantages of making channels using wet chemical etching include the low number of process steps, the ability to precisely control the geometry of the etched feature, and the ability to provide these etched features in a homogeneous substrate that has the same material properties throughout. The chemical etching process described herein uses an etchant, and optionally a solubilizer, to controllably etch polymers such as polyimide, liquid crystal polymer, and polycarbonate. Etching methods such as plasma etching and laser etching can be advantageous when a dry process is preferable.

Chemical Etching

An advantage of using an adhered layer as an etch stop include being able to use an etchant that will etch the dielectric layer without etching the adhered layer, or etching the adhered layer at a slower rate. The highly alkaline developing solution, referred to herein as an etchant, comprises an alkali metal salt and optionally a solubilizer. A solution of an alkali metal salt alone may be used as an etchant for polyimide but has a low etching rate when etching LCP and polycarbonate. However, when a solubilizer is combined with the alkali metal salt etchant, it can be used to effectively etch polyimide polymers having carboxylic ester units in the polymeric backbone, LCPs, and polycarbonates.

Water soluble salts suitable for use in an aspect of the present invention include, for example, potassium hydroxide (KOH), sodium hydroxide (NaOH), substituted ammonium hydroxides, such as tetramethylammonium hydroxide and ammonium hydroxide or mixtures thereof. Useful alkaline etchants include aqueous solutions of alkali metal salts including alkali metal hydroxides, particularly potassium hydroxide, and their mixtures with amines, as described in U.S. Pat. Nos. 6,611,046 B1 and 6,403,211 B1. Useful concentrations of the etchant solutions vary depending upon the thickness of the dielectric film to be etched, as well as the type and thickness of the photoresist chosen. Typical useful concentrations of a suitable salt range in one embodiment from about 30 wt. % to 55 wt. % and in another embodiment from about 40 wt. % to about 50 wt. %. Typical useful concentrations of a suitable solubilizer range in one embodiment from about 10 wt. % to about 35 wt. % and in another embodiment from about 15 wt. % to about 30 wt. %. The use of KOH with a solubilizer is preferred for producing a highly alkaline solution because KOH-containing etchants provide optimally etched features in the shortest amount of time. The etching solution is generally at a temperature of from about 50° C. (122° F.) to about 120° C. (248° F.) preferably from about 70° C. (160° F.) to about 95° C. (200° F.) during etching.

Typically the solubilizer in the etchant solution is an amine compound, preferably an alkanolamine. Solubilizers for etchant solutions according to the present invention may be selected from the group consisting of amines, including ethylene diamine, propylene diamine, ethylamine, methylethylamine, and alkanolamines such as ethanolamine, diethanolamine, propanolamine, and the like. The etchant solution, including the amine solubilizer, according to the present invention works most effectively within the above-referenced percentage ranges. This suggests that there may be a dual mechanism at work for etching polycarbonates or liquid crystal polymers, i.e., the amine acts as a solubilizer for the polycarbonate or liquid crystal polymers most effectively within a limited range of concentrations of alkali metal salt in aqueous solution. Discovery of this most effective range of etchant solutions allows the manufacture of flexible printed circuits based upon polycarbonates or liquid crystal polymers having finely structured features previously unattainable using standard methods of drilling, punching and laser ablation.

Under the conditions of etching, unmasked areas of a dielectric film substrate become soluble by action of the solubilizer in the presence of a sufficiently concentrated aqueous solution of, e.g., an alkali metal salt. The time required for etching depends upon the type and thickness of polycarbonate film to be etched, the composition of the etching solution, the etch temperature, spray pressure, and the desired depth of the etched region.

Plasma Etching

The dielectric film can also be etched by a “dry” plasma process. In such a method, a plasma is formed in a controlled environment at a pressure from about 1 to 500 m Torr and a frequency from 100 khz to 2.45 Ghz. Typical process conditions include using a specific gas such as oxygen or a mixture of gases such as halocarbons. With these conditions, the highly reactive ions in the plasma easily react chemically to remove atoms of dielectric material from the film. The dielectric material can be removed selectively by using a metal mask or photoresist polymer mask. The molecular structures of different dielectric materials have different etch rates. A plasma etching method is anisotropic compared to wet chemistry process.

Laser Etching

The dielectric film can also be etched by a laser process. A laser (having a highly concentrated beam of light) such as a Carbon Dioxide laser, operating at wavelengths of 2.6 to 8.3 μm; an excimer laser operating at wavelengths of 93 nm, 248 nm, 308 nm or 353 nm; or a YAG laser (yttrium-Aluminum-Garnet) laser, operating at wavelengths of 650 nm to 1.064 μm, can ablate or vaporize dielectric material. Lasers can be tuned to selectively remove a first layer of a material without etching an adjeacent second layer by changing the wavelength, type of laser, and/or types of gasses used. Lasers typically leave a charred residue that then needs to be removed with subsequent processing.

Materials

Suitable dielectric materials for the present invention include any dielectric material that is etchable by a different means than an adjacent adhered layer acting as an etch stop. An aspect of the present invention provides an etched dielectric film for use in microfluidic devices. Etching of films to introduce precisely shaped openings, voids, recesses and regions of controlled thickness is most effective with films that do not swell in the presence of alkaline etchant solutions. Swelling changes the thickness of the film and may cause localized delamination of resist. This can lead to irregular thicknesses and irregular shaped features due to etchant migration into the delaminated areas. Dielectric films of the present invention may be, but are not limited to, polycarbonates, liquid crystal polymers, or polyimides, including polyimide polymers having carboxylic ester units in the polymeric backbone. Other materials suitable dielectric films for use in the present invention include any dielectric material that can be etched under different conditions than an adjacent adhered layer. Examples of suitable materials include, but are not limited to polyethylene terephthalate (PET), polyethylene naphthalene (PEN), substituted and unsubstituted PET and PEN, PET and PEN blends, and PET and PEN copolymers.

Preferably, the film being etched is substantially fully cured.

Current flexible circuits typically use dielectric substrate materials having a starting thickness of more than 25 μm thick. Typically, the substrates are about 25 μm to about 400 μm thick. In a finished product, suitable thicknesses in etched and non-etched regions can range from about 5 μm to about 400 μm. The desired thickness will depend on the planned use of the article and desired depth of channels, reservoirs, etc. In one embodiment of the present invention, the base polymer substrate is no thicker than 125 μm and channel depth would be between 25 μm and 75 μm deep.

There are several construction options that could be employed to build a microfluidic polymer based device. The construction material set of each device will be contingent on the market served and the analyte being measured and various other factors.

Chemical etching of films to introduce precisely-shaped openings, voids, recesses and other regions of controlled thickness preferably include the use of a film that does not swell in the presence of alkaline etchant solutions. Swelling changes the thickness of the film and may cause localized delamination of resist. This can lead to loss of control of etched film thickness and irregular shaped features due to etchant migration into the delaminated areas. Controlled etching of films, according to the present invention, is most successful with substantially non-swelling polymers. “Substantially non-swelling” refers to a film that swells by such an insignificant amount when exposed to an alkaline etchant as to not hinder the thickness-reducing action of the etching process. For example, when exposed to some etchant solutions, some polyimide will swell to such an extent that their thickness cannot be effectively controlled in reduction. However, when an opening is being etched entirely through the thickness of a polymer layer, swelling is less of an issue so a broader range of materials may be used.

Polyimide

Polyimide film is a commonly used substrate for flexible circuits that fulfill the requirements of complex, cutting-edge electronic assemblies. The film has excellent properties such as thermal stability and low dielectric constant.

As described in U.S. Pat. No. 6,611,046 B1 it is possible to produce chemically etched vias and through holes in flexible polyimide circuits, as needed for electrical interconnection between the circuit and a printed circuit board. Complete removal of polyimide material, for hole formation, is relatively common. Controlled etching without hole formation is very difficult when commonly used polyimide films swell uncontrollably in the presence of conventional etchant solutions. Most commercially available polyimide film comprises monomers of pyromellitic dianhydride (PMDA), or oxydianiline (ODA), or biphenyl dianhydride (BPDA), or phenylene diamine (PPD). Polyimide polymers including one or more of these monomers may be used to produce film products designated under the trade name KAPTON H, K, E films (available from E. I. du Pont de Nemours and Company, Circleville, Ohio) and APICAL AV, NP films (available from Kaneka Corporation, Otsu, Japan). Films of this type swell in the presence of conventional chemical etchants. Swelling changes the thickness of the film and may cause localized delamination of resist. This can lead to loss of control of etched film thickness and irregular shaped features due to etchant migration into the delaminated areas.

In contrast to other known polyimide films there is evidence to show controllable thinning of APICAL HPNF films (available from Kaneka Corporation, Otsu, Japan). The existence of carboxylic ester structural units in the polymeric backbone of non-swelling APICAL HPNF film signifies a difference between this polyimide and other polyimide polymers that are known to swell in contact with alkaline etchants.

APICAL HPNF polyimide film is believed to be a copolymer that derives its ester unit containing structure from polymerizing of monomers including p-phenylene bis(trimellitic acid monoester anhydride). Other ester unit containing polyimide polymers are not known commercially. However, to one of ordinary skill in the art, it would be reasonable to synthesize other ester unit containing polyimide polymers depending upon selection of monomers similar to those used for APICAL HPNF. Such syntheses could expand the range of polyimide polymers for films, which, like APICAL HPNF, may be controllably etched. Materials that may be selected to increase the number of ester containing polyimide polymers include 1,3-diphenol bis(anhydro-trimellitate), 1,4-diphenol bis(anhydro-trimellitate), ethylene glycol bis(anhydro-trimellitate), biphenol bis(anhydro-trimellitate), oxy-diphenol bis(anhydro-trimellitate), bis(4-hydroxyphenyl sulfide) bis(anhydro-trimellitate), bis(4-hydroxybenzophenone) bis(anhydro-trimellitate), bis(4-hydroxyphenyl sulfone) bis(anhydro-trimellitate), bis(hydroxyphenoxybenzene), bis(anhydro-trimellitate), 1,3-diphenol bis(aminobenzoate), 1,4-diphenol bis(aminobenzoate), ethylene glycol bis(aminobenzoate), biphenol bis(aminobenzoate), oxy-diphenol bis(aminobenzoate), bis(4 aminobenzoate) bis(aminobenzoate), and the like.

Polyimide films may be etched using solutions of potassium hydroxide or sodium hydrozide alone, as described in U.S. Pat. No. 6,611,046 B1, or using alkaline etchant containing a solubilizer.

LCP

Liquid crystal polymer (LCP) films represent suitable materials as substrates for flexible circuits having improved high frequency performance, lower dielectric loss, better chemical resistance, and less moisture absorption than polyimide films.

LCP films represent suitable materials as substrates for flexible circuits having improved high frequency performance, lower dielectric loss, and less moisture absorption than polyimide films. Characteristics of LCP films include electrical insulation, moisture absorption less than 0.5% at saturation, a coefficient of thermal expansion approaching that of the copper used for plated through holes, and a dielectric constant not to exceed 3.5 over the functional frequency range of 1 kHz to 45 GHz. These beneficial properties of liquid crystal polymers were known previously but difficulties with processing prevented application of liquid crystal polymers to complex electronic assemblies. The etchant with solubilizer described herein makes possible the use of LCP film instead of polyimide as an etchable substrate for microfluidic devices. A similarity between liquid crystal polymers and APICAL HPNF polyimide is the presence of carboxylic ester units in both types of polymer structures.

Non-swelling films of liquid crystal polymers comprise aromatic polyesters including copolymers containing p-phenyleneterephthalamide such as BIAC film (Japan Gore-Tex Inc., Okayama-Ken, Japan) and copolymers containing p-hydroxybenzoic acid such as LCP CT film (Kuraray Co., Ltd., Okayama, Japan).

Some embodiments of the present invention preferably use a laminated composite in which the dielectric layer is extruded and tentered (biaxially stretched) liquid crystal polymer films. A process development, described in U.S. Pat. No. 4,975,312, provided multiaxially (e.g., biaxially) oriented thermotropic polymer films of commercially available liquid crystal polymers (LCP) identified by the trade names VECTRA (naphthalene based, available from Hoechst Celanese Corp.) and XYDAR (biphenol based, available from Amoco Performance Products). Multiaxially oriented LCP films of this type represent suitable substrates for flexible printed circuits and circuit interconnects suitable for production of device assemblies such as microfluidic devices.

The development of multiaxially oriented LCP films, while providing a film substrate for flexible circuits and related devices, was subject to limitations in methods for forming and bonding such flexible circuits. An important limitation was the lack of a chemical etching method for use with LCP. Without such a technique, complex circuit structures such as unsupported, cantilevered leads or through holes or vias having angled sidewalls could not be included in a printed circuit design.

### Polycarbonate

Characteristics of polycarbonate films include electrical insulation, moisture absorption less than 0.5% at saturation, a dielectric constant not to exceed 3.5 over the functional frequency range of 1 kHz to 45 GHz, better chemical resistance when compared to polyimide, lower modulus may enable more flexible circuits, and the optical clarity of polycarbonate films will allow the formation of microfluidic devices to be used in conjunction with a variety of spectrographic techniques in the ultraviolet and visible light domains. Polycarbonates also have lower water absorption than polyimide and lower dielectric dissipation.

While polycarbonate films may be etched using solutions of potassium hydroxide and sodium hydroxide alone, the etch rate is so slow that only the surface of the film can be effectively etch. Etching capabilities to produce flexible printed circuits having thinned polycarbonate substrates or polycarbonate substrates with voids and/or selectively formed indented regions require specific materials and process capabilities not previously disclosed. Until now, low-cost patterning of the polycarbonate film has been a key issue that prevented polycarbonate films from being applied in high volume applications. However, as is disclosed and taught herein, polycarbonates can be readily etched when a solubilizer is combined with highly alkaline aqueous etchant solutions that comprise, for example, water soluble salts of alkali metals and ammonia.

Examples of suitable non-swelling polycarbonate materials include substituted and unsubstituted polycarbonates; polycarbonate blends such as polycarbonate/aliphatic polyester blends, including the blends available under the trade name XYLEX from GE Plastics, Pittsfield, Mass., polycarbonate/polyethyleneterephthalate(PC/PET) blends, polycarbonate/polybutyleneterephthalate (PC/PBT) blends, and polycarbonate/poly(ethylene 2,6-naphthalate) ((PPC/PBT, PC/PEN) blends, and any other blend of polycarbonate with a thermoplastic resin; and polycarbonate copolymers such as polycarbonate/polyethyleneterephthalate (PC/PET) and polycarbonate/polyetherimide (PC/PEI). Another type of material suitable for use in the present invention is a polycarbonate laminate. Such a laminate may have at least two different polycarbonate layers adjacent to each other or may have at least one polycarbonate layer adjacent to a thermoplastic material layer (e.g., LEXAN GS125DL which is a polycarbonate/polyvinyl fluoride laminate from GE Plastics). Polycarbonate materials may also be filled with carbon black, silica, alumina and the like or they may contain additives such as flame retardants, UV stabilizers, pigment and the like.

Adhered Layer

In an aspect of the present invention, an adhered layer adjacent to the dielectric layer acts as an etch stop. Essentially any adhered layer that is not etchable, or is etchable at a slower rate, by the same etching method used to etch the dielectric layer could be used. The adhered layer may be an adhesive or a non-adhesive.

Adhesive Adhered Layer

Microfluidic devices may comprise layers of materials adhered together. Suitable adhesives include pressure sensitive adhesives, thermoset adhesives, and a thermoplastic adhesive, such as epoxies, acrylates, and thermoplastic polyimide (TPPI). In some applications, a wet chemically etchable adhesive may be preferred. In other applications, a non-chemically etchable adhesive may be preferred. The adhesive may be of any suitable thickness, but is typically applied in a very thin layer, e.g., in the range of about 0.5 to about 5 μm thick. In one embodiment, the adhesive layer thickness is about 2 μm thick. When a thermoplastic adhesive is used to adhere two layers together, typically the layers to be joined are heated to temperatures typically within 20° C. of each other, but about 30 to 60° C. above the Tg of the adhesive material, then the layers and the adhesive are pressed together, using heated opposing platens or rolls.

Non-Adhesive Adhered Layer

As an alternative to using an adhesive layer as an etch stop, a composite structures may be formed with a non-adhesive adhered layer that acts as an etch stop. Thermoplastic films, such as liquid crystal polymers and polycarbonate, are suitable for forming a composite structure without the use of an adhesive. Thermoplastic films may be bonded to a supporting dielectric film or metal foil by using an etching solution containing an alkali metal salt and solubilizer to etchant treat a surface of the film. A metal foil having at least one acid treated surface will form a bond to the etchant treated surface upon application of about 100 psi to about 500 psi pressure to the supporting metal foil and the thermoplastic film at temperatures that cause the thermoplastic film to flow. The bonding surface of the metal foil is typically treated with a strongly acidic etch composition. The second side of the thermoplastic-metal laminate may also be etchant treated so that it may be bonded to a second metal foil.

Flash lamp polymer pretreatment and sealing technology can be used to self-seal multiple layers of LCP or other semicrystalline polymer films creating an adhesiveless seal as described in U.S. Pat. No. 5,032,209. The surface of at least one semicrystalline polymer film is irradiated with radiation, which is strongly absorbed by the polymer and of sufficient intensity and fluence to cause an amorphized layer. The semicrystalline polymer surface is thus altered into a new morphological state by radiation such as an intense short pulse UV excimer laser or short pulse duration, high intensity UV flashlamp. The resulting polymer layer with the amorphous surface may then be heat-sealed to another polymeric material by conventional means.

Once the composite structure is formed with a dielectric layer adjacent a non-adhesive adhered layer, the dielectric layer can be etched with the adhered layer acting as an etch stop.

Methods

The combination of precision substrate and conductor patterning, as described herein, may be used for making microfluidic devices such as lab on a chip substrates. In particular the manufacturing techniques used in continuous web flexible circuit processing make it possible to make high volume, low cost microfluidic substrates. Flexible circuitry is an optional solution for the miniaturization and movement needed for state-of-the-art electronic assemblies. Thin, lightweight and ideal for complicated devices, flexible circuit design solutions range from single-sided conductive paths to complex, multilayer three-dimensional packages.

The formation of openings, recessed or thinned regions, channels, reservoirs, unsupported leads, through holes and other circuit features in the film typically requires protection of portions of the polymeric film using a mask of a photo-crosslinked negative acting, aqueous processable photoresist, or a metal mask. During the etching process the photoresist exhibits substantially no swelling or delamination from the dielectric film.

While photoresist is commonly used as a mask for substrate etching to form dielectric patterns or features, a metal also can be used. For example, a metal layer may be made by sputtering a thin layer of copper then plating additional copper to form a 1-5 μm thick layer. Photoresist is then applied to the metal layer, exposed to a pattern of radiation and developed to expose areas of the metal layer. The exposed areas of the metal layer are then etched to form a pattern. The remaining photoresist is then stripped off, leaving a metal mask. Metals other than copper may also be used as a mask. Electrolytic plating and electroless plating methods may be used to form the metal layer. Using metal masks instead of photoresist masks will typically result in increased sidewall etched angles and increased etched feature sizes.

Negative photoresists suitable for use with dielectric films according to the present invention include negative acting, aqueous developable, photopolymer compositions such as those disclosed in U.S. Pat. Nos. 3,469,982; 3,448,098; 3,867,153; and 3,526,504. Such photoresists include at least a polymer matrix including crosslinkable monomers and a photoinitiator. Polymers typically used in photoresists include copolymers of methyl methacrylate, ethyl acrylate and acrylic acid, copolymers of styrene and maleic anhydride isobutyl ester and the like. Crosslinkable monomers may be multiacrylates such as trimethylol propane triacrylate.

Commercially available aqueous base, e.g., sodium carbonate developable, negative acting photoresists employed according to the present invention include polymethylmethacrylates photoresist materials such as those available under the trade name RISTON from E.I. duPont de Nemours and Co., e.g., RISTON 4720. Other useful examples include AP850 available from LeaRonal, Inc., Freeport, N.Y., and PHOTEC HU350 available from Hitachi Chemical Co. Ltd. Dry film photoresist compositions under the trade name AQUA MER are available from MacDermid, Waterbury, Conn. There are several series of AQUA MER photoresists including the “SF” and “CF” series with SF120, SF125, and CF2.0 being representative of these materials.

The dielectric film of the polymer-metal laminate may be etched at several stages in the flexible circuit manufacturing process. Introduction of an etching step early in the production sequence can be used to thin the bulk film or only selected areas of the film while leaving the bulk of the film at its original thickness. Alternatively, thinning of selected areas of the film later in the flexible circuit manufacturing process can have the benefit of introducing other circuit features before altering film thickness. Regardless of when selective substrate thinning occurs in the process, film-handling characteristics remain similar to those associated with the production of conventional flexible circuits.

A process for the manufacture of flexible circuits may comprise the step of etching, which may be used in conjunction with various known pre-etching and post-etching procedures. The sequence of such procedures may be varied as desired for the particular application. A typical additive sequence of steps employing chemical etching may be described as follows:

Aqueous-processable photoresists are laminated over both sides of a substrate comprising dielectric film with a thin copper side, using standard laminating techniques. Typically, the substrate has a polymeric film layer of from about 25 μm to about 75 μm, with the copper layer being from about 1 to about 5 μm thick. The thickness of the photoresist is from about 10 μm to about 50 μm. Upon imagewise exposure of both sides of the photoresist to ultraviolet light or the like, through a mask, the exposed portions of the photoresist become insoluble by crosslinking. The resist is then developed, by removal of unexposed polymer with a dilute aqueous solution, e.g., a 0.5-1.5% sodium carbonate solution, until desired patterns are obtained on both sides of the laminate. The copper side of the laminate is then further plated to desired thickness. Chemical etching of the polymer film then proceeds by placing the laminate in a bath of etchant solution, as previously described, at a temperature of from about 50° C. to about 120° C. to etch away portions of the polymer not covered by the crosslinked resist. This exposes certain areas of the original thin copper layer. The resist is then stripped from both sides of the laminate in a 2-5% solution of an alkali metal hydroxide at from about 25° C. to about 80° C., preferably from about 25° C. to about 60° C. Subsequently, exposed portions of the original thin copper layer are etched using an etchant that does not harm the polymer film, e.g., PERMA ETCH, available from Electrochemicals, Inc.

In an alternate substractive process employing chemical etching, the aqueous processable photoresists are again laminated onto both sides of a substrate having a polymer film side and a copper side, using standard laminating techniques. The substrate consists of a polymeric film layer about 25 μm to about 75 μm thick with the copper layer being from about 5 μm to about 40 μm thick. The photoresist is then exposed on both sides to ultraviolet light or the like, through a suitable mask, crosslinking the exposed portions of the resist. The image is then developed with a dilute aqueous solution until desired patterns are obtained on both sides of the laminate. The copper layer is then etched to obtain circuitry, and portions of the polymeric layer thus become exposed. An additional layer of aqueous photoresist is then laminated over the first resist on the copper side and crosslinked by flood exposure to a radiation source in order to protect exposed polymeric film surface (on the copper side) from further etching. Areas of the polymeric film (on the film side) not covered by the crosslinked resist are then etched with the etchant solution containing an alkali metal salt and solubilizer at a temperature of from about 70° C. to about 120° C., and the photoresists are then stripped from both sides with a dilute basic solution, as previously described.

It is possible to introduce regions of controlled thickness into the dielectric film of the flexible circuit using controlled chemical etching either before or after the etching of through holes and related voids that completely removes dielectric polymer materials as required to introduce conductive pathways through the circuit film. The step of introducing standard voids in a printed circuit typically occurs about mid-way through the circuit manufacturing process. It is convenient to complete film etching in approximately the same time frame by including one step for etching all the way through the substrate and a second etching step for etching recessed regions of controlled depth. This may be accomplished by suitable use of photoresist, crosslinked to a selected pattern by exposure to ultraviolet radiation. Upon development, removal of photoresist reveals areas of dielectric film that will be etched to introduce recessed regions.

Alternatively, openings or recessed regions may be introduced into the polymer film as an additional step after completing other features of the flexible circuit. The additional step requires lamination of photoresist to both sides of the flexible circuit followed by exposure to crosslink the photoresist according to a selected pattern. Development of the photoresist, using the dilute solution of alkali metal carbonate described previously, exposes areas of the dielectric film that will be etched to produce openings, indentation, and thinned regions of film. After allowing sufficient time to etch openings and indentations and thinned regions of desired depth into the dielectric substrate of the flexible circuit, the protective crosslinked photoresist is stripped as before, and the resulting circuit is rinsed clean.

The process steps described above may be conducted as a batch process using individual steps or in automated fashion using equipment designed to transport a web material through the process sequence from a supply roll to a wind-up roll, which collects mass produced circuits that include selectively thinned regions and indentations of controlled depth in the polymer film. Automated processing uses a web handling device that has a variety of processing stations for applying, exposing and developing photoresist coatings, as well as etching and plating the metallic parts and etching the polymer film of the starting metal to polymer laminate. Etching stations include a number of spray bars with jet nozzles that spray etchant on the moving web to etch those parts of the web not protected by crosslinked photoresist.

To create finished products such as flexible circuits, interconnect bonding tape for “TAB” (tape automated bonding) processes, flexible circuits, and the like, conventional processing may be used to add multiple layers and plate areas of copper with gold, tin, or nickel for subsequent soldering procedures and the like as required for reliable device interconnection.

Changing Surface Properties

The surface properties of the microfluidic devices can be changed by subjecting the surfaces, or portions thereof, to different types of treatments. For example, a diamond-like film such as diamond-like carbon (DLC) can be applied to the fluid-transporting channels of microfluidic devices, for example as described in WO 01/67087 A2, to make them more hydrophilic or more hydrophobic. Making the surface more hydrophilic will allow an aqueous-based fluid to travel more easily and more readily through the channels. Making the surface more hydrophobic could provide a moisture barrier where desired. Corona, plasma, and flash lamp treatments can also be used to make the surface more hydrophobic or hydrophilic.

The diamond-like film, which can be applied using a plasma deposition method can be doped with various materials such as nitrogen, oxygen, fluorine, silicon sulfur, titanium, and copper, as taught in WO 01/67087 at p. 18, which allows the properties of the surface to be tailored for its particular use, e.g., by creating varying degrees of hydrophobicity.

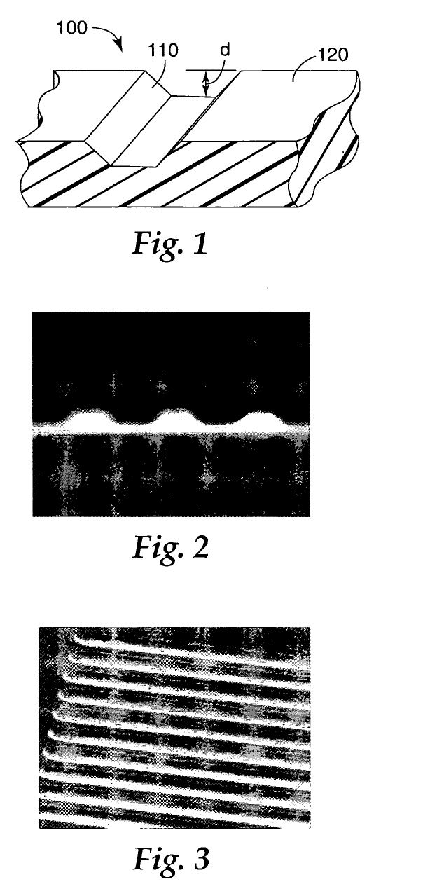

FIG. 1 illustrates an embodiment of the present invention comprising article 100 having an etched channel 110 formed in a dielectric film 120, and having a depth, d. To make a channel in a dielectric film as shown in FIG. 1, the chemical etching of the dielectric must be well controlled, which requires non-swelling materials as previously described. A channel may be up to about 75% of the thickness of the dielectric material in which it is etched. Greater depths can lead to stability problems. Typical channel dimensions of interest for microfluidic devices are a channel width of about 10 μm to about 200 μm and a depth of about 10 μm to about 70 μm. The walls of the channels are sloped having a sidewall angle in the range of 25° to about 75°, relative to the surface of the dielectric film.

FIG. 2 is a photomicrograph digital image of a cross section of an APICAL HPNF film having several etched channels as per the present invention. The channels were formed by applying a solution of potassium hydroxide with a solubilizer to a polyimide film covered by a patterned layer of photoresist. The resulting construction is a series of well-defined channels in the polymer. The slope of the channel walls is a result of the etchant concentration, etching conditions, type of resist material (e.g. metal mask or polymeric photoresist), and the substrate being etched. In the case of FIG. 2, the dielectric substrate was APICAL HPNF film. Similar etching results may also be achieved with liquid crystal polymers and polycarbonates using a suitable etchant solution, as taught above.

FIG. 3 is a scanning electron micrograph digital image showing a top view of the etched film of FIG. 2. The channels have a width of about 150 μm and a depth of about 38 μm, with a variation in the depth of the features of +/−10% across the array.

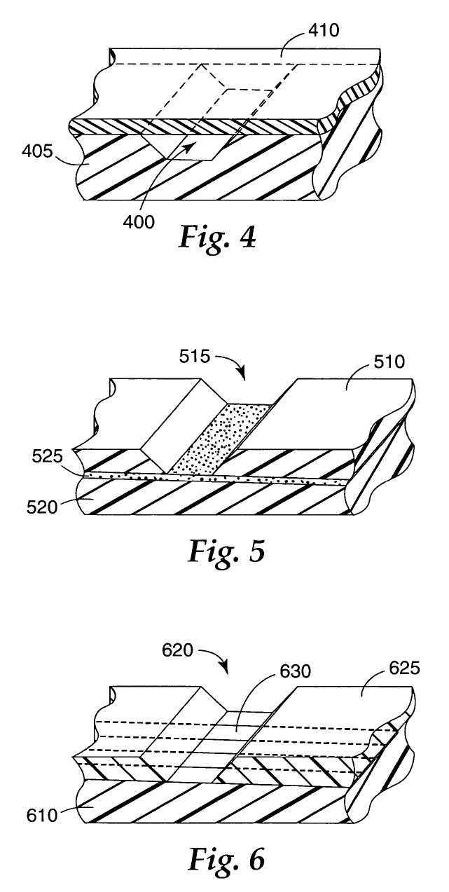

FIG. 4 illustrates an embodiment of the present invention in which a cap layer 410 is placed over a channel that has been etched in a planar polymer substrate 405, thereby creating a microfluidic tube 400. The cap layer may be a thermoplastic film, a tape, or an adhesive layer, which has been laminated or adhered to a surface of the dielectric film. The cap layer may be continuous or may have openings through its thickness. For example, in embodiment of the present invention in which a well or reservoir is etched in the dielectric substrate, it may be desirable to have a cap layer with opening over the wells or reservoirs. Such a structure could be useful for introducing analyte into a test well, for example as required for an electrochemical sensor application.

FIG. 5 illustrates another embodiment of the present invention in which a channel is formed by chemical etching. Channel 515 is etched in polymer layer 510. Polymer layer 510 may be laminated directly to the base layer 520 if both materials are thermoplastic polymers, otherwise an adhesive layer 525 may be used to join the two layers. Channel 515 may be etched into polymer layer 510 before or after it is combined with base layer 520. This approach will allow dissimilar material sets to be combined and accomplish a controlled depth channel and or features. For example, channel 515 may be etched into a KAPTON E film to form polymer layer 510 before it is attached to base layer 520, which may be a made of a different polyimide, such as APICAL HPNF or UPILEX S, available from Ube Industries, Tokyo, Japan. This will allow tailoring of the mechanical properties of the resulting microfluidic device.

In addition, the use of two different types of dielectric films with different etch rates and/or different resistance to a particular etchant can allow one layer of film to be etched down to the interface with a second non-etchable or etch-resistant material that acts as an etch stop. Alternatively, two layers of the same type of material may be adhered together with a non-etchable or etch-resistant adhesive or non-adhesive layer. This will allow one layer to be etched down to the adhered layer, which acts as an etch stop. The etching may be chemical, laser, or plasma etching. In this instance, “non-etchable” means the adhered layer is not etchable, or is etchable at a slower rate, by the same means as the adjacent dielectric film. The adhered layer could be etchable by a different etching method than the dielectric film or by the same method, but under different conditions, e.g., different solution concentrations, different laser energy settings, etc. In some embodiments, it may be desirable to etch areas of the adhered layer to expose areas of material underlying, or embedded in, the adhered layer. For example, it may be desirable to expose a portion of an underlying conductive layer to provide a conductive feature, such as an electrode, accessible from the opening etched in the dielectric film. The conductive layer may be formed, for example, by laminating or depositing, e.g., sputtering, a conductive material on the exposed side of the adhered layer after it has been adhered to the dielectric film. Alternatively, the adhered layer could be applied to an existing conductive layer and the dielectric layer could then be applied on the adhered layer. Raised conductive features may also be embedded in the adhered layer by different methods. A conductive layer could be formed such that it has raised areas prior to application of the adhered material. The adhered material may then be applied to the conductive layer in the form of a liquid or in a sheet having sufficient pliability to conform to the shape of the conductive layer. Alternatively, if the adhered layer is applied to the dielectric layer first, it could be shaped or patterned to have depressed areas that would be filled by a deposited conductive material. The area of conductive material exposed by removal of the adhered layer may be an electrode or another electrical feature.

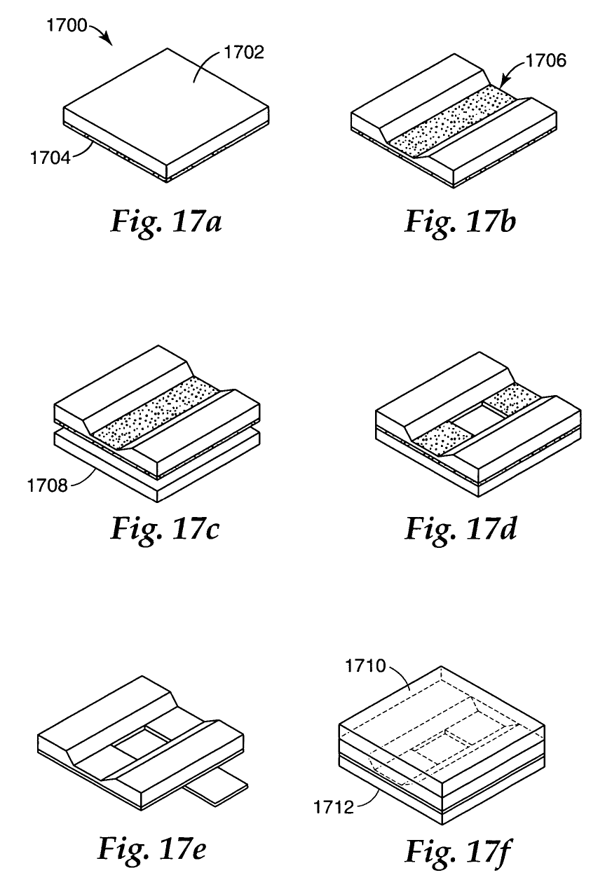

FIGS. 17a-17f illustrate an embodiment of a method of the present invention. Article 1700 begins with the dielectric layer 1702 with attached adhered layer 1704 as shown in FIG. 17a. FIG. 17b shows an etched channel 1706 formed in a dielectric film 1702. FIG. 17c shows metal layer 1708 attached to adhered layer 1704. FIG. 17d shows portions of adhered layer 1704 etched to reveal portions of metal layer 1708. FIG. 17e shows metal layer 1708 after it has been patterned. Metal layer 1708 may be an electrode. FIG. 17f shows cover layer 1710 added as well as stiffener 1712. Typical channel dimensions of interest for microfluidic devices are a channel width of about 10 μm to about 200 μm and a depth of about 10 μm to about 70 μm. The walls of the channels are sloped typically having a sidewall angle in the range of 25° to about 75°, relative to the surface of the dielectric film. Metal layer 1708 may be sputtered on adhered layer 1704. It may be sputtered on adhered layer 1704 before or after adhered layer 1704 is adhered to dielectric layer 1702. Adhered layer 1704 may be laminated to, or coated on, dielectric layer 1702. Article 1700 may be suitable for use in an integrated circuit.

The dependence of etch rates on polymer type and etchant solution concentration can be used advantageously to make a desired article. For example, an etchable polymer film having a patterned layer of photoresist could be exposed to a solution having a particular etchant concentration to achieve uniform depth etching of the exposed areas. Subsequently, different areas could be exposed, or some of the already exposed areas could be covered, then the polymer film could be exposed to an etchant solution having a different etchant concentration to achieve different depths of etching. Alternatively, articles could be made of different types of etchable polymer, in different regions, that are etched at different rates when exposed to the same etchant solution. In another embodiment, a polymer laminate having its outer layer made of different polymer materials with different etch rates could be exposed to an etchant solution to obtain etched features having different depths on each side of the film. This could allow areas of the article to be etched to different depths in a single step. Alternatively a laminate may be used that is a made up of a layer of etchable polymer material and a layer of non-etchable or etch resistant material, such as non-etchable thermoplastics, e.g., polyvinylfluoride (PVF); metals, e.g., copper, nickel, gold and the like; and non-etchable or etch-resistant adhesives, which will serve as an etch stop when etching through areas of the etchable polymer. With these embodiments, complex three-dimensional shapes may be etched into thick polymer films (e.g., to make customized reaction chambers).

Electrodes such as high voltage electrodes, reference electrodes, working electrodes and counter electrodes could be configured in several ways depending on the application and function of the device. Electrodes could be made of any noble metal or plated noble metal and could be positioned in any portion of the structure including the channel bottom, bottom of a well in a channel, in the side of the channel and or in the cap. These electrodes could also be in any of the other structures such as reaction chambers and reservoirs. Typical electrode materials could consist of solid metal structures like gold, silver or platinum or noble metal plated on to copper traces.

FIG. 6 illustrates another embodiment of the present invention in which electrodes are located at the bottom of a channel. This embodiment consists of a flexible circuit 610, which comprises a dielectric material having conductive traces on, or embedded in, its surface. Channel 620 may be positioned over portions of the traces of the circuit to form at least one electrode 630 for performing electrochemical assays. Channel 620 may be formed by etching dielectric layer 625, after it has been applied to flexible circuit 610. If an adhesive is used to apply dielectric layer 625 to flexible circuit 610, the adhesive is preferably wet chemical etchable (or removable by another method) so the conductive trace at the bottom of the channel 620 can be exposed to create the electrodes 630. A suitable wet etchable adhesive is a thermoplastic polyimide (TPPI) available under the tradename PIXEO from Kaneka, Tokyo, Japan. The adhesive layer thickness is typically between about 2 μm and about 5 μm.

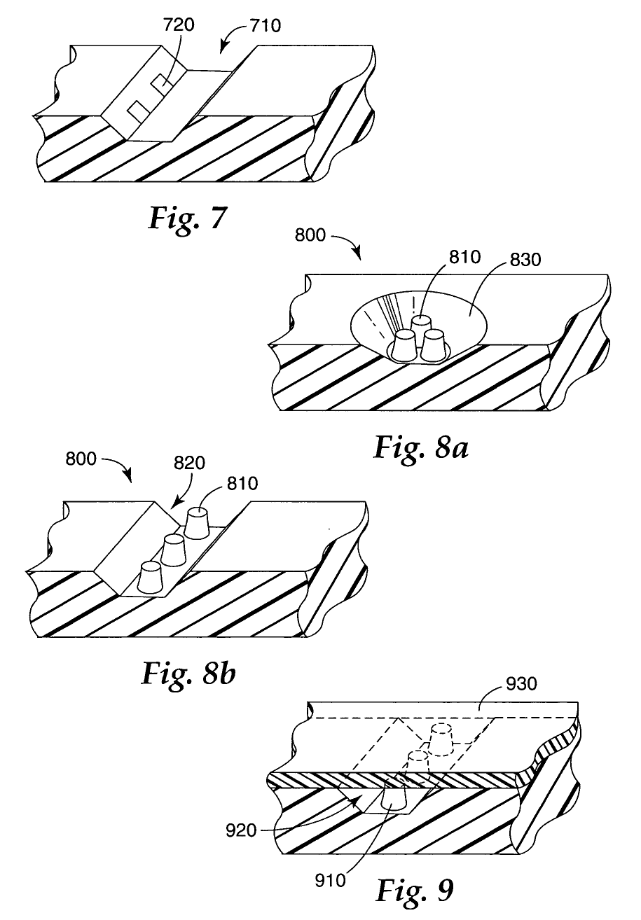

FIG. 7 illustrates another embodiment of the present invention in which electrodes 720 are located on the sidewalls of channel 710. Some of the most important characteristics of an electrode are the predictable surface area, the type of metal deposited, and the purity of that metal deposited. One method for making electrodes 720 would be to first fabricate a circuit composite as described in U.S. Pat. No. 6,372,992. The '992 patent discloses hermetically sealing circuit traces between at least two liquid crystal polymer (LCP) layers. A layer of photoresist is then laminated to both sides of the circuit composite structure. The photoresist is exposed to ultraviolet (UV) light through a phototool or mask to define desired dielectric features (e.g., vias, channels, reservoirs, etc.) that will be etched on one or both sides of the circuit composite. Then the photoresist is developed with a 0.5-1.5% aqueous solution of sodium carbonate to obtain the desired photoresist pattern over the LCP layer(s). The exposed LCP is then etched away from the top and sides of the circuit traces with a solution of 35-55% KOH and 15-30% ethanolamine solubilizer at a temperature of 70-95° C. For the embodiment shown in FIG. 7, the resulting structure, at this point, would consist of channel 710 transversed by raised conductive features. The portions of the circuit traces exposed in channel 710 may then be removed with an etchant that is commercially available under the trade name PERMA-ETCH from Electrochemicals Inc., Maple Plain, Minn. or known laser ablation techniques to produce the electrodes 720 shown in FIG. 7.

FIGS. 8 & 9 show a metal bump which was formed by filling a via with metal and selectively removing the dielectric material around the via to expose the bump. The bump can function as an electrode for the device and can provide support for the cap material so that it won't sag when spanning a wide indentation. The process of forming these metal bumps is disclosed in co-pending U.S. patent application Ser. No. 10/791,966.

FIGS. 8a and 8b illustrate other embodiments of the present invention in which a sensor 800 contains at least one conductive bump 810 in an open well or reservoir 830 (FIG. 8a) or in an open channel 820 (FIG. 8b). The difference between the open well and open channel configurations is the shape of the indention made in the dielectric film around the conductive bumps. These indentions may be of any shape that can be produced by conventional photoimaging processes including truncated cones (FIG. 8a), truncated cylinders, polyhedrons, channels, and combinations thereof.

The at least one conductive bump may be used as an electrode in an electrochemical sensor. The sensor may interface with a measurement device (not shown) that measures the electrochemical reaction between an analyte and reagent in contact with the sensor electrodes.

FIG. 9 illustrates another embodiment of the present invention in which a sensor contains conductive bumps 910 in a closed channel 920. A cap layer 930 has been added on the surface of the dielectric film to cover the etched channel. The cap layer may be a thermoplastic film, a tape or adhesive layer, which has been laminated or adhered to the first surface of the dielectric film. The cap layer may be solid or have openings through its thickness. An opening through the cap layer may be useful for introducing an analyte as required for an electrochemical sensor application.

In this embodiment of the current invention, the conductive bumps provide the added utility of serving as structural supports for the cap layer to prevent collapse or sagging of the cap layer. In this embodiment the conductive nature of the bumps may be used or they may serve purely as structural members.

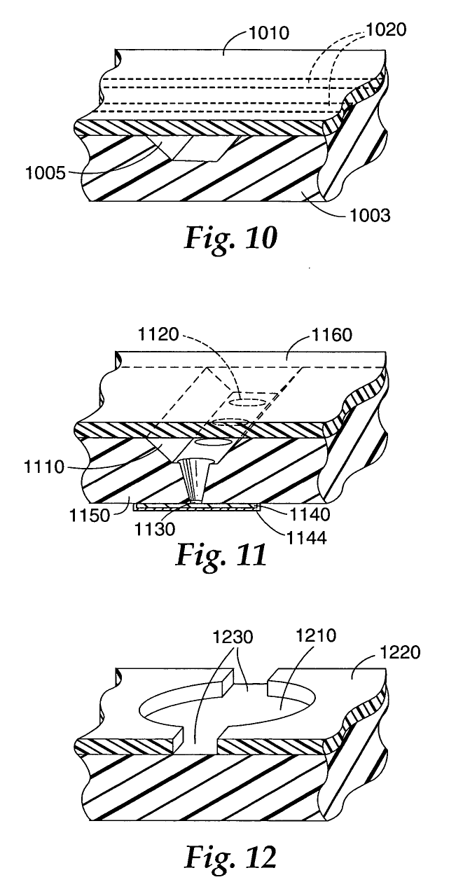

FIG. 10 illustrates another embodiment of the present invention in which channel 1005 in dielectric layer 1003 is covered with a cap layer 1010 having transverse traces 1020 that function as electrodes, in a top electrode configuration, over channel 1005. Cap layer 1010 may be laminated to dielectric layer 1003. The traces will be embedded between the cap layer and the dielectric layer as disclosed in U.S. Pat. No. 6,372,992.

FIG. 11 illustrates another embodiment of the present invention in which a chemically etched channel 1110 contains sampling wells 1120. Sampling wells 1120 may be formed by laser ablation or chemical etching. At the bottoms of sampling wells 1120 are metal electrodes 1130. Metal electrodes 1130 are typically pads of solid gold or electroplated gold positioned on copper conductor layer 1140, which is attached to the dielectric base layer 1150. An optional cover layer 1144 may be added to cover conductor layer 1140. A cap layer 1160 may be laminated or adhered over channel 1110 as previously described. When working with liquid crystal polymer and polycarbonate, a flashlamp treatment can be used to prepare the materials for heat sealing as detailed in U.S. Pat. No. 5,032,209

Many microfluidic “lab on a chip” constructions require chambers, wells, and reservoirs. Chemical etching according to the present invention, can produce cost effective structures with an infinite variety of shapes. The etching may be partial, i.e., etching only part way through the dielectric layer, or full, i.e., etching completely through the dielectric layer. FIG. 12 illustrates another embodiment of the present invention in which base dielectric layer 1220 contains etched reservoir 1210, which may be virtually any desired size and shape. Analyte samples may be introduced into reservoir 1210 through the fluid ports 1230 which may be connected to wicking channels or other means for sample introduction. A cap layer (not shown) may be added atop the reservoir if a closed reservoir is desired.

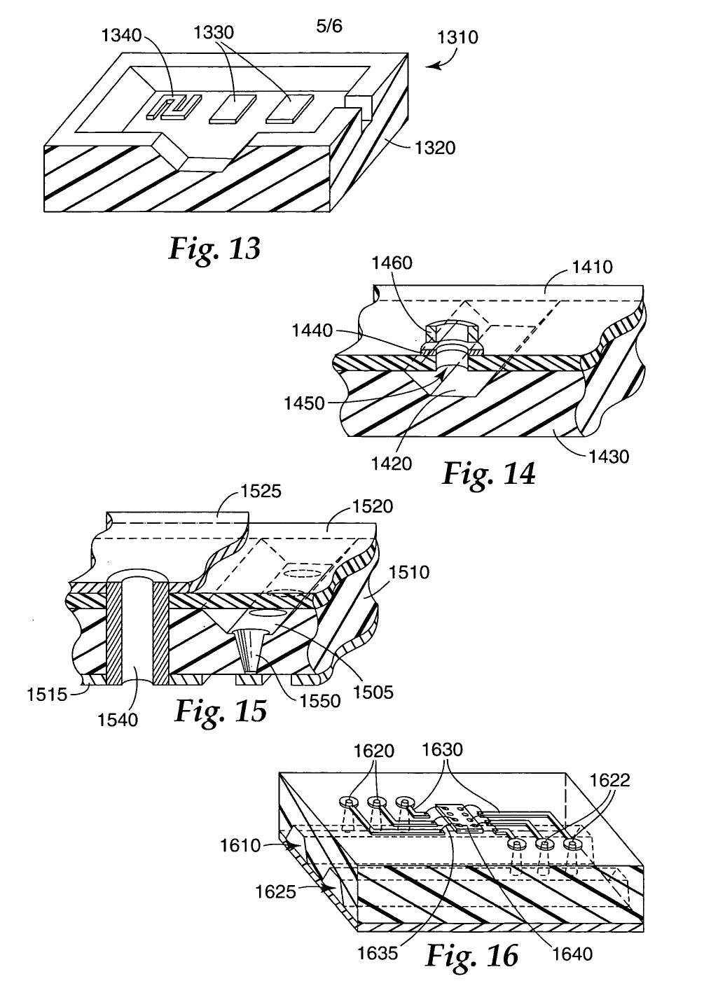

FIG. 13 illustrates another embodiment of the present invention in which a reaction chamber 1310 is formed by partially or fully etching an opening in a dielectric layer 1320. The chamber may be used for a single purpose, such as a single type of assay, or may contain one or more functional areas 1330 having coatings or depositions to enable certain assays or reactions. For example, different reagents may be applied to the specified functional areas 1330 so that two or more assays can be carried out using a single analyte sample. For an example of a microfluidic reactor having multiple probe sites for DNA hybridization assays, see Lenigk, R., et al., “Plastic Biochannel Hybridization Devices: A New Concept for Microfluidic DNA Arrays,” Analytical Biochemistry 311 (2002), pp. 40-49 (Elsevier Science 2002). Heaters can be made in the reaction chamber by depositing (e.g., via screen printing) carbon ink, silver epoxy, and/or alloys such a sputtered or vapor coated nickel/chrome/iron alloy available under the trade name INCONEL from Special Metals Corporation, New Hartford, N.Y. to form an “on-board” heater 1340. Having a heater in the reaction chamber can be useful to control the kinetics, or other aspects of, a reaction. For example, in polymerase chain reactors for DNA analysis, the reaction temperatures must be controlled at each step in the process. Other structures that may be fabricated in a reaction chamber include electrophoretic electrodes for separations and pumps for electrolytic pumping.

FIG. 14 illustrates another embodiment of the present invention that includes a feature for connecting a fluid tube to an etched “lab on a chip” structure through a cap layer. The cap layer 1410 sits atop a fluid channel, reservoir, or reaction chamber 1420 that has been etched in the base substrate 1430. An annular ring of copper 1440 is deposited, formed, adhered, or otherwise patterned on the top surface of the cap layer. The copper ring 1440 may be used as a mask for laser ablation or chemical etching to create an opening 1450 through the cap layer 1410. If a laser is used to form the opening, it is preferable to have a metal layer, or other suitable material, in the channel to prevent the laser from penetrating into the bottom of the channel. The opening could also, in some cases, be created by punching. A nipple 1460 can be soldered or adhered to the copper ring 1440 to accommodate a micro fluid hose connection (not shown) to move fluid in or out of the channel, reservoir, or reaction chamber 1420.

FIG. 15 illustrates another embodiment of the present invention that includes a device having a channel 1505 etched in base dielectric layer 1510, which base dielectric layer has a layer of metal 1515 on its bottom surface. The device also has a cap layer 1520, which can have a metal layer 1525 on its top surface. The cap layer 1520 is laminated or adhered to the top surface of the base dielectric layer 1510. Metal layers 1515 and 1525 may then be patterned to form traces using conventional techniques known in both the flexible circuit and printed circuit board arts. Using an opening formed from patterning metal layer 1525, through via 1540 may be laser drilled though the base dielectric layer 1510. The via may then be plated with conductive material to provide electrical interconnection between metal layers 1515 and 1525. Sampling well(s) 1550 may also be formed in the base dielectric by chemical etching or laser ablation.

Polyimide and other polymer base constructions commonly used in electronics industry have the advantage of being an acceptable chip package substrate enabling the chip to be on board if required and or enabling inter connections schemes used to interconnect the module to a device, board, connector, cable or jumper flex circuit. FIG. 16 illustrates an embodiment of the present invention that includes a microfluidic device having an integrated circuit (IC) chip mounted on the backside. For example FIG. 16 shows the backside of the microfluidic device of FIG. 15 interconnected with an IC chip. This device has two fluid channels 1610, 1625 for introducing samples into the sample wells under the electrode contacts 1620, 1622. These contacts may be connected to an IC chip 1640 for data capture and analysis through circuit traces 1630 and wirebonds 1635 or circuit traces 1630 and solderballs (not shown) if a flipchip configuration were used. Alternatively the chip could be a radio frequency identification (RFID) chip for transmitting the test results to a base station. Additional traces might be added to provide a means for interconnection the microfluidic device to a measurement apparatus or as an antenna for the RFID chip.

It will be appreciated by those of skill in the art that, in light of the present disclosure, changes may be made to the embodiments disclosed herein without departing from the spirit and scope of the present invention.

What is claimed is:

1. An article comprising:
a microfluidic device comprising (1) a dielectric film having a first surface and a second surface and comprising an etchable polymer, said dielectric film having an etched opening extending from said first surface to said second surface; and (2) an adjacent layer adhered to said second surface of said dielectric film, wherein said adhered layer is not etchable in the same manner as the dielectric layer.

2. An article according to claim 1 wherein the polymer is selected from the group consisting of polyimides having carboxylic ester units in the polymeric backbone, liquid crystal polymers, and polycarbonates.

3. An article according to claim 1 wherein the polymer is selected from the group consisting of polyethylene terephthalates and polyethylene naphthalates.

4. An article according to claim 1 wherein the adhered layer is comprised of an adhesive selected from the group consisting of pressure sensitive adhesives, thermoplastic adhesives, and thermoset adhesives.

5. An article according to claim 1 wherein the opening forms a channel or a reservoir.

6. An article according to claim 1 wherein a portion of the surface of a conductive material underlying the adhered layer is exposed.

7. An article according to claim 6 wherein the conductive material is an electrode.

8. An article according to claim 1 further comprising an integrated circuit.

9. A method comprising:
providing a dielectric film having a first surface and a second surface and comprising an etchable polymer and having an adhered layer adjacent said second surface of said dielectric film; and
etching an opening from said first surface to said second surface of said dielectric film wherein said adhered layer acts as an etch stop during the etching of said opening.

10. A method according to claim 9 wherein the polymer is selected from the group consisting of polyimides having carboxylic ester units in the polymeric backbone, liquid crystal polymers, and polycarbonates.

11. An method according to claim 9 wherein the polymer is selected from the group consisting of polyethylene terephthalates and polyethylene naphthalates.

12. An method according to claim 9 wherein the adhered layer comprises an adhesive selected from the group consisting of pressure sensitive adhesives, thermoplastic adhesives, and thermoset adhesives.

13. A method according to claim 9 wherein the opening is a channel or a reservoir.

14. A method according to claim 9 wherein a portion of the adhered layer is removed to expose a portion of the surface of an underlying conductive material.

15. A method according to claim 14 wherein the conductive material is an electrode.

16. A method according to claim 14 wherein the conductive material is sputtered onto the adhered layer.

17. A method according to claim 9 wherein the means of etching the dielectric substrate is chemical etching.

18. A method according to claim 9 wherein the means of etching the dielectric substrate is plasma etching.

19. A method according to claim 9 wherein the means of etching the dielectric substrate is laser etching.

20. An article comprising:
a microfluidic device comprising (1) a dielectric film having a first surface and a second surface and comprising a chemically etchable polymer selected from the group consisting of polyimides having carboxylic ester units in the polymeric backbone, liquid crystal polymers, and polycarbonates, said dielectric film having a chemically etched opening extending from said first surface to said second surface; and (2) an adhered layer adjacent said second surface of said dielectric film, wherein said adhered layer is not chemically etchable in the same manner as the dielectric layer.

21. An article according to claim 20 wherein the adhered layer comprises an adhesive selected from the group consisting of pressure sensitive adhesives, thermoplastic adhesives, and thermoset adhesives.

22. An article according to claim 20 wherein the opening forms a channel or a reservoir.

23. An article according to claim 20 wherein a portion of the surface of a conductive material underlying the adhesive is exposed.

24. An article according to claim 23 wherein the conductive material is an electrode.

25. An article according to claim 20 further comprising an integrated circuit.

26. A method comprising:
providing a dielectric film having a first surface and a second surface and comprising a chemically etchable polymer selected from the group consisting of polyimides having carboxylic ester units in the polymeric backbone, liquid crystal polymers, and polycarbonates and having an adhered layer adjacent said second surface of said dielectric film; and
chemically etching an opening from said first surface to said second surface of said dielectric film wherein said adhered layer acts as an etch stop during the chemical etching of said opening.

27. A method according to claim 26 wherein the opening is a channel or a reservoir.

28. A method according to claim 26 wherein a portion of the adhered layer is removed to expose a portion of the surface of an underlying conductive material.

29. A method according to claim 28 wherein the conductive material is an electrode.

30. A method according to claim 28 wherein the conductive material is sputtered onto the adhered layer.
